(19) United States
(12) Patent Application Publication
(10) Pub. No.: US 2026/0043185 A1
(43) Pub. Date: Feb. 12, 2026

(54) GASKET AND WASHER INCLUDING THE SAME

(71) Applicant: SAMSUNG ELECTRONICS CO., LTD., Suwon-si (KR)

(72) Inventors: Jangwon LEE, Suwon-si (KR); Nohcheol PARK, Suwon-si (KR); Jayeon SEO, Suwon-si (KR)

(73) Assignee: SAMSUNG ELECTRONICS CO., LTD., Suwon-si (KR)

(21) Appl. No.: 19/285,738

(22) Filed: Jul. 30, 2025

Related U.S. Application Data
(63) Continuation of application No. PCT/KR2025/010564, filed on Jul. 17, 2025.

(30) Foreign Application Priority Data
Aug. 9, 2024 (KR) 10-2024-0106698

(51) Int. Cl. D06F 37/26; C08L 53/02

(52) U.S. Cl. CPC D06F 37/266; C08L 53/02; C08L 2205/03

(57) ABSTRACT

A washer including a main body including an opening configured to allow insertion of laundry into the main body; a door configured to open or close the opening; a tub in the main body; a drum in the tub, the drum configured to be rotatable; and a gasket connecting the main body and the tub so that, based on the opening being closed by the door, the gasket is in contact with at least a portion of the door, wherein the gasket includes a thermoplastic elastomer (TPE) including a styrene-ethylene-butylene-styrene (SEBS) block copolymer, a polypropylene (PP) copolymer, and a thermoplastic polyolefin (TPO) of 0.1 to 5 wt % based on a total weight of the TPE, and the TPE has a hardness of 31 to 33 shore A.

### CROSS-REFERENCE TO RELATED APPLICATION(S)

This application is a continuation of International Application No. PCT/KR2025/010564 designating the United States, filed on Jul. 17, 2025, in the Korean Intellectual Property Receiving Office, and claiming priority to Korean Patent Application No. 10-2024-0106698, filed on Aug. 9, 2024, in the Korean Intellectual Property Office, the disclosures of each of which are incorporated by reference herein in their entireties.

### TECHNICAL FIELD

An embodiment of the disclosure relates to a gasket and, specifically, to a gasket applicable to a washer.

### BACKGROUND ART

In general, a washer may wash laundry, such as clothes or bedding, by using electric power. The washer may remove dirt from the laundry through the interaction of water, detergent, and the rotating drum.

The washer may include a main body having an opening formed for putting in laundry, a door for opening and closing the opening, a tub disposed inside the main body to store water, and a drum rotatably installed inside the tub. The washer may perform washing by causing laundry inside the drum to rise and then fall along the inner wall of the drum as the drum rotates.

The washer may include a gasket that is positioned between the drum and the door to seal between the drum and the door when the opening is closed by the door. The gasket is composed of a thermoplastic elastomer, TPE, and may have properties, such as elasticity, heat resistance, high-temperature resilience, and chemical resistance. The gasket may be manufactured by injection-molding the composition, and the gasket may reduce vibration and noise generated in the washer by preventing vibration generated by rotation of the drum from being transferred to the main body.

Meanwhile, in order for the gasket to effectively reduce vibration and noise, the hardness of the material forming the gasket needs to be below a predetermined level. Further, to maintain a smooth surface of the gasket during the process of injection molding of the gasket, the flowability of the composition flowing inside the injection molds needs to be at a predetermined level or higher.

The above-described information may be provided as related art for the purpose of helping understanding of the disclosure. No claim or determination is made as to whether any of the foregoing is applicable as background art in relation to the disclosure.

### DISCLOSURE OF INVENTION

### Technical Problem

A washer according to an embodiment of the disclosure may include a gasket composed of a composition having hardness and flowability below a predetermined level.

### Solution to Problems

Aspects of embodiments of the disclosure will be set forth in part in the description which follows and, in part, will be apparent from the description, or may be learned by practice of the presented embodiments.

According to an embodiment of the disclosure, a washer includes a main body including an opening configured to allow insertion of laundry into the main body; a door configured to open or close the opening; a tub in the main body; a drum in the tub, the drum configured to be rotatable; and a gasket connecting the main body and the tub so that, based on the opening being closed by the door, the gasket is in contact with at least a portion of the door, wherein the gasket includes a thermoplastic elastomer (TPE) including styrene-ethylene-butylene-styrene (SEBS) block copolymer, a polypropylene (PP) copolymer, and a thermoplastic polyolefin (TPO) of 0.1 to 5 wt % based on a total weight of the TPE, and the TPE has a hardness of 31 to 33 shore A.

According to an embodiment of the disclosure, the TPO may be present in an amount of 0.1 to 2 wt % based on the total weight of the TPE.

According to an embodiment of the disclosure, the TPO may be present in an amount of 1 to 2 wt % based on the total weight of the TPE.

According to an embodiment of the disclosure, the TPO may be present in an amount of 0.025 to 0.05 wt % based on a weight of the SEBS block copolymer.

According to an embodiment of the disclosure, the TPO may be a composition formed by copolymerization of PP and α-olefin.

According to an embodiment of the disclosure, the PP copolymer may include a random type PP copolymer.

According to an embodiment of the disclosure, the random type PP copolymer may be composed of a compound of PP and at least one of ethylene, butene, butadiene, and synthetic rubber.

According to an embodiment of the disclosure, a melt flow index (MFI) of the TPE may be 0.5 to 2.5 g/10 min.

According to an embodiment of the disclosure, the melt flow index (MFI) of the TPE may be 1.5 to 2.1 g/10 min.

According to an embodiment of the disclosure, the TPE may include modified polyphenylene ether (mPPE). The mPPE may be present in an amount of 1 to 5 wt % based on a total weight of the TPE.

According to an embodiment of the disclosure, a specific gravity of the TPE may be 0.96 to 1.

According to an embodiment of the disclosure, a gasket is configured to connect a main body and a tub included in a washer, and configured to be in close contact with at least a portion of a door of the washer, the gasket including a thermoplastic elastomer (TPE) including a styrene-ethylene-butylene-styrene (SEBS) block polymer, a polypropylene (PP) copolymer, and a thermoplastic polyolefin (TPO) of 0.1 to 5 wt % based on a total weight of the TPE, wherein the TPE has a hardness of 31 to 33 shore A.

According to an embodiment of the disclosure, the TPO may be present in an amount of 0.1 to 2 wt % based on the total weight of the TPE.

According to an embodiment of the disclosure, the TPO may be present in an amount of 1 to 2 wt % based on the total weight of the TPE.

According to an embodiment of the disclosure, the TPO may be present in an amount of 0.025 to 0.05 wt % based on a weight of the SEBS block copolymer.

According to an embodiment of the disclosure, the thermoplastic polyolefin may be a composition formed by copolymerization of PP and α-olefin.

According to an embodiment of the disclosure, the PP copolymer may include a random type PP copolymer.

According to an embodiment of the disclosure, the random type PP copolymer may be composed of a compound of PP and at least one of ethylene, butene, butadiene and synthetic rubber.

According to an embodiment of the disclosure, a melt flow index (MFI) of the TPE may be 0.5 to 2.5 g/10 min.

According to an embodiment of the disclosure, a melt flow index (MFI) of the TPE may be 1.5 to 2.1 g/10 min.

### BRIEF DESCRIPTION OF DRAWINGS

The above and other aspects, features, and advantages of certain embodiments of the disclosure will be more apparent from the following description taken in conjunction with the accompanying drawings, in which:

FIG. 1 illustrates a washer with a portion thereof cut out, according to an embodiment of the disclosure;

FIG. 2 is a side cross-sectional view illustrating a washer according to an embodiment of the disclosure;

FIG. 3 is a perspective view illustrating a gasket included in a washer according to an embodiment of the disclosure;

FIG. 4A illustrates morphology when TPO is prepared by a copolymerization method according to an embodiment of the disclosure;

FIG. 4B illustrates morphology when TPO is prepared by a simple blending type according to an embodiment of the disclosure; and

FIG. 5 illustrates a portion of a surface of a gasket according to an embodiment of the disclosure.

### MODE FOR THE INVENTION

An embodiment of the disclosure and terms used therein are not intended to limit the technical features described in the disclosure to specific embodiments, and should be understood to include various modifications, equivalents, or substitutes of the embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order).

However, in the disclosure, the terms “front and rear direction”, “left and right direction”, and “upper and lower direction” to be used below may be used with respect to the illustrated drawings, and the shape and position of each component are not limited thereto.

According to an embodiment, each component (e.g., a module or a program) of the above-described components may include a single entity or multiple entities. Some of the plurality of entities may be separately disposed in different components.

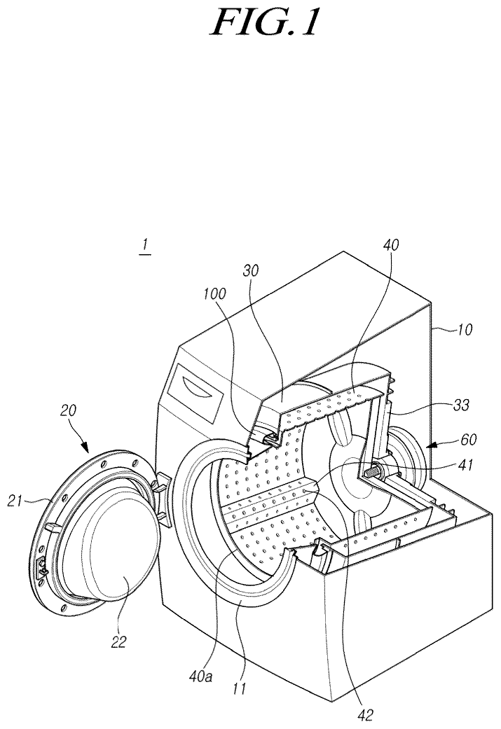

The washer (e.g., the washer 1 of FIG. 1) described below may be understood as an example to help understand the disclosure, and it may be understood that various changes may be made thereto. Further, in some of the accompanying drawings, the dimensions of some components may be exaggerated rather than being shown at the actual scale to help understand the disclosure.

FIG. 1 illustrates a washer 1 with a portion thereof cut out, according to an embodiment of the disclosure.

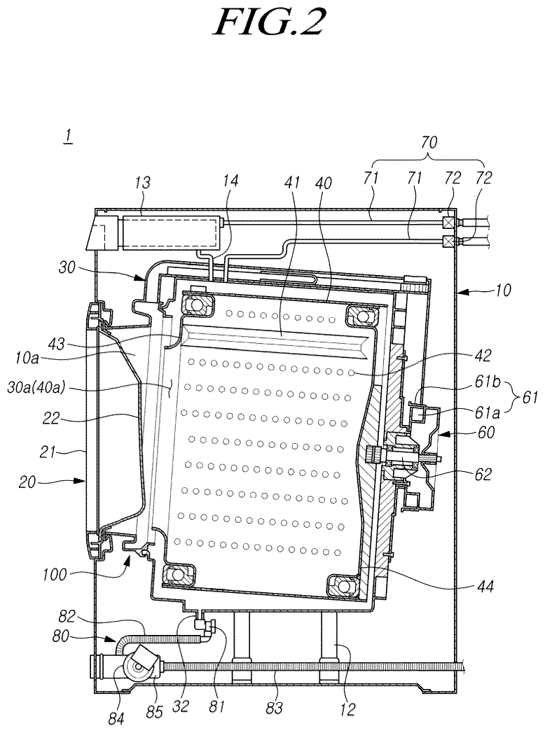

FIG. 2 is a side cross-sectional view illustrating a washer 1 according to an embodiment of the disclosure.

Referring to FIGS. 1 and 2, a washer 1 may include a main body 10 forming an exterior, a tub 30 installed inside the main body 10 to store water, a drum 40 rotatably disposed inside the tub 30, and a driving device 60 for driving the drum 40.

According to an embodiment, the washer 1 may include a main body 10. The main body 10 may have an overall hexahedral shape. The main body 10 may include an opening formed in one surface thereof. Two or more of the surfaces of the main body 10 may be integrally formed. Each surface of the main body 10 may be separately manufactured and assembled. The main body 10 may be, e.g., press-molded with an iron plate material or injection-molded with a resin material.

According to an embodiment, the front frame 11 of the main body 10 may have an opening 10a. The opening 10a of the front frame 11 may be opened and closed by the door 20 installed in the front frame 11.

According to an embodiment, a door 20 for opening and closing the corresponding opening may be disposed on a portion corresponding to the opening of the main body 10. The door 20 may be rotatably coupled to a hinge fixed to one surface of the main body 10. For example, at least a portion of the door 20 may be provided to be transparent or translucent so as to be visible inside. The user may open and close the door 20 to put the laundry into the drum 40 positioned inside the main body 10 or withdraw the laundry from the drum 40. For example, the door 20 may be locked by a locking device (not shown) so as not to be opened while the washer 1 is running. In an example, the door 20 may include a door frame 21 and a glass member 22. The glass member 22 may be formed of, e.g., a transparent tempered glass material to see through the inside of the main body 10, but the disclosure is not limited thereto.

According to an embodiment, the washer 1 may include a tub 30 fixedly disposed inside the main body 10. The tub 30 may have a substantially cylindrical shape with one side open. A tub opening 30a may be provided in the front surface of the tub 30 at a position corresponding to the opening of the main body 10. The tub 30 may store washing water. A drain port 32 for draining washing water may be provided under the tub 30. The drain port 32 may be connected to, e.g., the drain device 80.

According to an embodiment, the washer 1 may include a damper 12. The damper 12 may be provided to connect the main body 10 and the tub 30. One side of the damper 12 may be fixed to the inner surface of the main body 10 and the other side of the damper 12 may be fixed to the tub 30. The damper 12 may be provided to attenuate vibration by absorbing vibration energy transferred to the tub 30 and/or the main body 10 when the drum 40 rotates.

According to an embodiment, the washer 1 may include a drum 40 provided inside the tub 30. The drum 40 may have a substantially cylindrical shape with one side open. A front plate 43 and a rear plate 44 may be disposed on the front surface and the rear surface, respectively, of the drum 40. The front plate 43 may be provided with a drum opening at a position corresponding to the opening of the main body 10 and the tub opening 30a of the tub 30. The drum 40 may receive laundry. The drum 40 may be disposed to receive rotational power from the driving device 60 and rotate inside the tub 30. The drum 40 may perform washing, rinsing, and/or spinning while rotating inside the tub 30.

According to an embodiment, the drum 40 may include a lifter 41 and/or a plurality of through holes 42. For example, the lifter 41 may lift the laundry while the drum 40 rotates so that the laundry repeatedly rises and falls, thereby evenly washing laundry on several surfaces thereof. The through hole 42 may be, e.g., a passage formed so that the washing water received in the tub 30 flows into the drum 40 or the washing water inside the drum 40 is discharged to the outside. In an example, the lifter 41 or the through hole 42 may be omitted.

According to an embodiment, the front portion of the tub 30 and the front portion of the drum 40 may have a tub opening 30a and a drum opening 40a, respectively, corresponding to the opening 10a of the front frame 11 to put laundry into the drum 40.

According to an embodiment, the washer 1 may include a driving device 60 for rotating the drum 40. The driving device 60 may include a driving motor 61 and a driving shaft 62 for transferring the driving force generated by the driving motor 61 to the drum 40. The driving motor 61 may include a fixed stator 61a and a rotor 61b that rotates by electromagnetically interacting with the stator 61a to convert an electric force into a mechanical rotational force. The rotational force generated by the driving motor 61 may be transferred to the drum 40 through the driving shaft 62. The driving shaft 62 may be press-fitted into the rotor 61b of the driving motor 61 to rotate together with the rotor 61b. The driving shaft 62 may, e.g., partially penetrate the rear wall of the tub 30 to connect the drum 40 and the driving motor 61. The driving device 60 may rotate the drum 40 forward or backward to perform washing, rinsing, and/or spinning operations.

According to an embodiment, the washer 1 may include a water supply device 70 for supplying washing water to the drum 40 and/or the tub 30. The water supply device 70 may include at least one water supply pipe 71 and at least one water supply valve 72. The at least one water supply pipe 71 may be provided to supply washing water into the tub 30 using an external water supply source. One of the at least one water supply pipe 71 may be connected to a detergent supply device 13 provided in the main body 10. Here, the detergent supply device 13 may be divided into a plurality of spaces, and each space may be provided with a detergent, a rinsing agent, or the like. The washing water passing through the detergent supply device 13 may be supplied to the tub 30 together with the detergent (or rinsing agent) through the detergent supply pipe 14. Another one of the at least one water supply pipe 71 may be directly connected to the tub 30. For example, the washing water supplied through the water supply pipe 71 directly connected to the tub 30 may be directly supplied to the tub 30 without going through an intermediate component such as the detergent supply device 13.

According to an embodiment, the washer 1 may include a drain device 80 for draining the washing water received in the drum 40 and/or the tub 30. The drain device 80 may include a drain valve 81, a first drain pipe 82, a second drain pipe 83, or a pump chamber 84. The drain device 80 may be disposed, e.g., under the tub 30 to discharge the washing water discharged from the tub 30 to the outside of the washer 1.

According to an embodiment, the drain valve 81 may be provided to open and close the drain port 32. When the drain valve 81 is opened, the washing water received in the tub 30 may flow through the drain port 32 to the drain device 80.

According to an embodiment, the first drain pipe 82 and the second drain pipe 83 may form a flow path that guides washing water to be discharged to the outside. For convenience of description, the upper stream of the pump chamber 84 is referred to as the first drain pipe 82 and the lower stream is referred to as the second drain pipe 83. The first drain pipe 82 and the second drain pipe 83 may be integrally formed. The first drain pipe 82 may have, e.g., one end connected to the drain port 32 and the other end connected to the pump chamber 84. The washing water may move into the pump chamber 84 along the first drain pipe 82. The second drain pipe 83 may have, e.g., one end connected to the pump chamber 84 and the other end connected to the outside of the washer 1. Accordingly, the washing water passing through the pump chamber 84 may be discharged to the outside of the washer 1 along the second drain pipe 83.

According to an embodiment, the pump chamber 84 may be provided under the tub 30 to store washing water drained from the tub 30. Inside the pump chamber 84, e.g., a drain pump 85 for discharging the stored washing water to the outside may be provided. The washing water pumped by the drain pump 85 may be guided to the outside of the main body 10 through the second drain pipe 83.

According to an embodiment, a gasket 100 may be disposed between the tub 30 and the door 20. The gasket 100 may also be referred to as a “diaphragm.” The gasket 100 may be disposed between the opening 10a of the front frame 11 and the opening 30a of the tub 30 to form a passage from the opening 10a of the front frame 11 to the opening 30a of the drum 30. The gasket 100 may reduce vibration transferred toward the front frame 10a when the drum 30 rotates.

According to an embodiment, a portion of the gasket 100 is disposed between the door 20 and the front frame 11 to prevent water collected in the tub 30 from leaking to the outside of the main body 10.

According to an embodiment, the gasket 100 may be formed of a material injection-molded from a thermoplastic elastomer (TPE). Since the thermoplastic elastomer has a predetermined elasticity at room temperature, the gasket formed of the thermoplastic elastomer may effectively dampen the vibration transferred from the tub 20 to the front frame 11 of the body 10, thereby reducing vibration and noise generated when the drum 40 rotates.

According to an embodiment, in order to effectively dampen the vibration generated by rotating the drum 40, the gasket 100 may be formed of a thermoplastic elastomer having a hardness of a predetermined level or less. For example, the gasket 100 may have a hardness of 31 to 33 Shore A.

According to an embodiment, in the process of injection-molding the gasket 100, the surface of the gasket 100 injection-molded in response to the flowability (or fluidity) of the thermoplastic elastomer, which is an injection-molding material, may be smoothed.

According to an embodiment, in order to smooth the surface of the gasket 100, it is required to increase the flowability of the thermoplastic elastomer used as the injection-molding material to reduce the amount of gas generated from the injection-molding material in the injection-molding process or penetrated during the injection-molding process.

For example, if the flowability of the thermoplastic elastomer is high, the amount of gas generated inside the thermoplastic elastomer, which is an injection-molding material before flowing into the mold device may decrease. For example, when the flowability of a thermoplastic elastomer is high, the amount of gas penetrating into the injection-molding material may decrease when the thermoplastic elastomer, which is an injection-molding material, flows inside the mold device.

According to an embodiment, the gasket 100 may be treated so that the surface thereof, which is to tightly contact the respective openings 10a, 30a, and 40a of the main body 10, the tub 30, and/or the drum 40 is smoothed so that the tight contact between the gasket 100 and the door 20 may be increased in a state in which the door 20 closes each of the openings 10a, 30a, and 40a. For this reason, vibration generated when the drum 40 rotates may be effectively reduced.

Described below is a thermoelastic elastomer which is a constituent material for effectively reducing vibration and noise generated when the drum 40 rotates by reinforcing sealability between the door 20 and the opening 10a of the front frame 11, the tub opening 30a of the tub 30, and the drum opening 40a of the drum 40 by the gasket 100 while maintaining a predetermined level of hardness of the gasket 100, according to the disclosure.

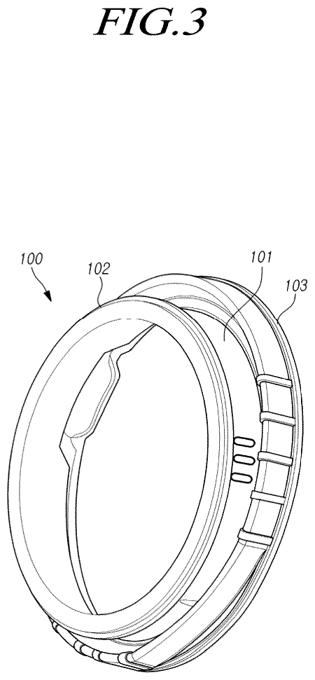

FIG. 3 is a perspective view illustrating a gasket 100 (e.g., the gasket 100 of FIG. 2) according to an embodiment of the disclosure.

The embodiment of FIG. 3 may be selectively combined with FIGS. 1 and 2.

Referring to FIG. 3, the gasket 100 may be disposed between the tub 30 (e.g., the tub 30 of FIG. 2) and the door 20 (e.g., the door 20 of FIG. 1). For example, one side of the gasket 100 may be disposed to surround the inner circumferential surfaces of the tub opening 30a and the drum opening 40a respectively formed in the tub 30 and the drum (e.g., the drum 40 of FIG. 1). For example, the other side of the gasket 100 may be disposed to surround the inside of the door 20.

According to an embodiment, the gasket 100 may form a passage to the opening 10a formed in the front frame 11 of the main body (e.g., the main body 10 of FIG. 1) and the tub opening 30a formed in the tub 30, reducing vibration transferred to the main body 10 when the drum 40 rotates.

According to an embodiment, a portion of the gasket 100 is disposed between the door 20 and the main body 10, thereby preventing water from the tub 30 from leaking to the outside of the main body 10.

According to an embodiment, the gasket 100 may include a body 101 generally formed in a cylindrical shape, a door coupling portion 102 connected to one end of the body 101 and connected to the door 20, and a drum coupling portion 103 connected to the other end of the body 101 and connected to the drum 40.

According to an embodiment, the gasket 100 may be manufactured by injection molding by a molding device. For example, the gasket 100 may be formed by injecting a thermoelastic elastomer which is an injection-molding material constituting the gasket 100 into a cavity having a shape corresponding to the gasket 100 by the molding device and hardening the thermoelastic elastomer.

According to an embodiment, the gasket 100 may have a predetermined level of hardness. For example, the gasket 100 may have a hardness (shore hardness) of 31 to 33 SHORE A. For example, the shore hardness may be measured using a standardized test procedure according to ISO 7619-1 or ASTM D2240 according to the shore test method and may be tested by measuring the indentation depth using a press with a spring formed of hard metal to press the material and/or specimen. The gasket 100 may attenuate vibration generated by rotating the drum 40 by having a relatively soft, predetermined level of hardness.

According to an embodiment, the thermoplastic elastomer constituting the gasket 100 may have a predetermined level of flowability (or fluidity) during the molding process. For example, the thermoplastic elastomer constituting the injection-molding material may be a material having a melt flow index (MFI or MI) of 0.5 to 2.5g/10 min, and preferably a material having a melt flow index of 1.5 to 2.1g/10 min. For example, the melt flow index may be measured according to a standard test method such as ASTM D1238, and may be defined as the weight of a material discharged through an orifice in a molten state under temperature and load conditions defined in the standard for 10 minutes.

According to an embodiment, the thermoplastic elastomer constituting the gasket 100 may include a styrene block copolymer, a polypropylene (PP) copolymer, and thermoplastic polyolefin (TPO).

According to an embodiment, the styrene block copolymer may include a styrene-ethylene-butylene-styrene (SEBS) block copolymer, a styrene-butadiene-styrene (SBS) block copolymer, a styrene-isoprene-styrene (SIS) block copolymer, a styrene-ethylene-ethylene-propylene-styrene (SEEPS) block copolymer, a styrene-ethylene-propylene-styrene (SEPS) block copolymer, and a crosslinkable styrene-ethylene-propylene-styrene (SEPS-V) block copolymer, but a styrene-ethylene-butylene-styrene (SEBS) block copolymer is preferable.

According to an embodiment, the thermoplastic elastomer may include a polypropylene copolymer having thermoplastic properties, and preferably, may include random type polypropylene (PP). Further, the thermoplastic elastomer may further include a polyvinyl chloride resin, a polystyrene resin, a polyethylene resin, an acrylic resin, and a nylon resin with thermoplastic properties.

According to an embodiment, the thermoplastic elastomer may include thermoplastic polyolefin. The thermoplastic polyolefin may maintain a predetermined level of hardness for the thermoplastic elastomer of the disclosure, and may provide a predetermined level of flowability to the thermoplastic elastomer in a molten state.

According to an embodiment, the thermoplastic polyolefin may be prepared by a simple blending method, a crosslinking method partially crosslinking or completely crosslinking synthetic rubber such as ethylene-propylene diene monomer (EPDM) by dynamic vulcanization, and a copolymerization method of polypropylene and α-olefin (α-olefin), but preferably it may be prepared by the copolymerization method.

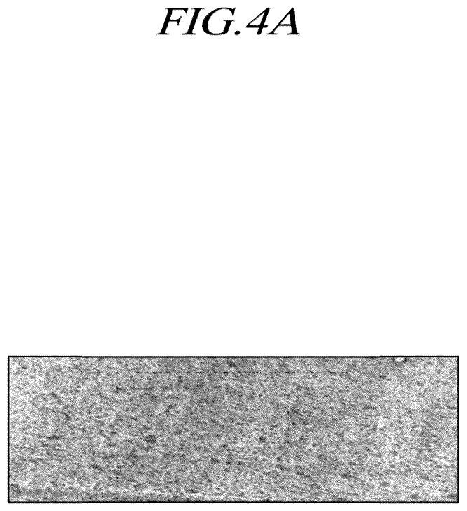

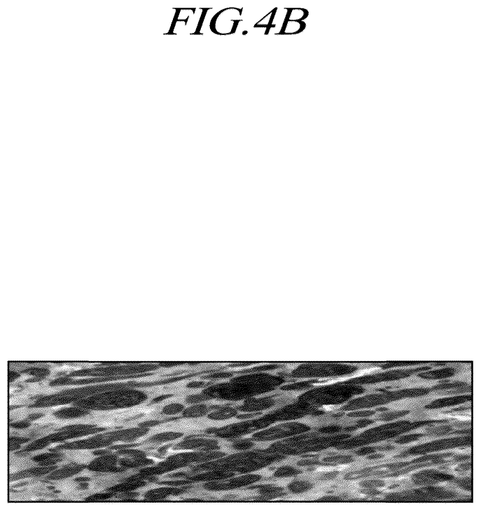

According to an embodiment, when the thermoplastic polyolefin is prepared by copolymerization, homo-PP may be used as the polypropylene. For example, the thermoplastic polyolefin may contain EPDM in the matrix of homo-PP as a domain-type dispersion phase. The morphology in which EPDM is present as a domain-type dispersion phase in the matrix of homo-PP is described in connection with FIGS. 4A and 4B.

According to an embodiment, dispersibility of PP, EPDM, and SEBS included in the material constituting the thermoplastic elastomer may be enhanced by adding a predetermined level of thermoplastic polyolefin, and thus hardness and flowability of the thermoplastic polyolefin may be enhanced due to the disposition structure of homo-PP and EPDM.

According to an embodiment, the thermoplastic elastomer may further include modified-polyphenylene ether (modified-PPE) to control hardness.

According to an embodiment, the thermoplastic elastomer may further include a softener such as silicone oil and mineral oil.

According to an embodiment, the thermoplastic elastomer may further include an inorganic filler such as calcium carbonate (CaCO₃), clay, diatomaceous earth, talc, barium sulfate (BaSO₄), magnesium carbonate (MgCO₃), metal oxide, graphite, and aluminum hydroxide (Al(OH)₃), and calcium carbonate is preferred.

According to an embodiment, the thermoplastic elastomer may be composed of the styrene block copolymer, the polypropylene copolymer, the thermoplastic polyolefin, m-PPE, and the inorganic filler in a predetermined ratio. Table 1 below shows the composition ratio, in wt %, of each composition in embodiments (e.g., embodiments 1 and 2) showing the thermoplastic elastomer of the disclosure, and comparative examples for comparison with the embodiments.

TABLE 1

| | Comparative | | |
|---|---|---|---|
| Constituent Material | Example | Embodiment 1 | Embodiment 2 |
| PP copolymer | 10 through 15 | 10 through 15 | 10 through 15 |
| SEBS | 25 through 40 | 25 through 39 | 25 through 38 |
| oil | 35 through 50 | 35 through 50 | 35 through 50 |
| calcium carbonate | 3 through 10 | 3 through 10 | 3 through 10 |
| TPO | — | 0.5 through 1 | 1 through 2 |
| m-PPE | 1 through 5 | 1 through 5 | 1 through 5 |

Referring to Table 1, embodiments 1 and 2 differ in the presence or absence of a thermoplastic polyolefin (hereinafter, referred to as TPO) from the comparative example, and embodiments 1 and 2 differ in the composition ratio of TPO and SEBS.

According to an embodiment, the thermoplastic elastomer of the disclosure may include TPO constituting 0.5 to 5% by weight of the total weight. For example, in embodiment 1, the composition ratio of the TPO may be 0.5 to 1 wt % of the total weight of the thermoplastic elastomer. For example, in embodiment 2, the composition ratio of the TPO may be 1 to 2 wt % of the total weight of the thermoplastic elastomer.

According to an embodiment, since the thermoplastic elastomer of the disclosure includes thermoplastic polyolefin, the hardness of the injection-molded product formed of the thermoplastic elastomer may be maintained at a predetermined level (e.g., 31 to 33 SHORE A), and flowability may be enhanced in a molten state. Hereinafter, the physical properties of embodiment 1 (e.g., embodiment 1 of Table 1) and embodiment 2 (e.g., embodiment 2 of Table 1) as compared with comparative example (e.g., comparative example of Table 1) are shown in Table 2.

TABLE 2

| | Comparative | | |
|---|---|---|---|
| Physical Properties | Example | Embodiment 1 | Embodiment 2 |
| flowability [g/10 min] | 0.1 | 0.7 | 2.1 |
| hardness [shore A] | 33 | 32 | 31 |

Referring to Table 2, it may be identified that the flowability of embodiments 1and 2 is increased and the hardness is decreased as compared with the comparative example. Therefore, it may be identified that the thermoplastic elastomer of the disclosure includes a predetermined ratio of thermoplastic polyolefin, thereby enhancing flowability and hardness.

According to an embodiment, when comparing embodiments 1 and 2, it may be identified that the degree of enhancement in flowability and hardness of embodiment 2 including thermoplastic polyolefin in a higher ratio is higher.

According to an embodiment, the flowability and hardness of the thermoplastic elastomer (embodiment 2) including the thermoplastic polyolefin in an amount of 1 to 2 wt % relative to the total weight of the thermoplastic elastomer are enhanced compared to the thermoplastic elastomer (embodiment 1) including the thermoplastic polyolefin constituting 0.1 to 1 wt % relative to the total weight of the thermoelastic elastomer. For example, in embodiment 2, the hardness may be reduced by about 0.32% as compared with embodiment 1 so that the vibration generated by the rotation of the drum 40 may be further attenuated. For example, in embodiment 2, flowability is increased by about three times compared to embodiment 1, so that exterior defects due to gas may occur less during the forming process.

According to an embodiment, since the thermoplastic elastomer of the disclosure includes thermoplastic polyolefin in a predetermined ratio, the injection-molded gasket 100 may maintain a low level of hardness, attenuating vibration caused by rotation of the drum 40, and reducing noise. Further, the thermoplastic elastomer of the disclosure includes thermoplastic polyolefin in a predetermined ratio, enhancing the flowability and smoothing the surface during injection molding. As a result, when the door 20 closes the opening 10a, the gasket 100 formed of the thermoplastic elastomer may increase tight contact between the door 20 and the body 10, and may prevent leakage of washing water (or rinsing water) stored in the tub 30 to the outside of the body 10.

According to an embodiment, the thermoplastic elastomer of the disclosure may have a specific gravity of 0.95 to 1, preferably 0.96 to 0.98. The thermoplastic elastomer may have a low level of specific gravity by including materials with a relatively low specific gravity.

According to an embodiment, the thermoplastic elastomer may maintain a relatively low specific gravity, thereby maintaining the hardness of the gasket 100 formed of the thermoplastic elastomer at a level of 31 to 33 Shore A.

According to an embodiment, when the gasket 100 formed of thermoplastic elastomer of the disclosure is applied to the washer 1, experimental examples related to reducing vibration and noise are shown in Table 3.

TABLE 3

| | |
|---|---|
| Comparative | |
| Example | Embodiment 1 |

| | | | | |
|---|---|---|---|---|
| Noise Level | 53 | dB | 50.7 | dB |
| Vibration Level | 0.51 | mm | 0.30 | mm |

Table 3 may be understood as records of noise and vibration levels when applying the gasket 100 formed of thermoelastic elastomer (e.g., embodiment 1 of Table 1 and/or Table 2) including a predetermined level of thermoplastic polyolefin to the washer 1 and noise and vibration levels when applying the gasket 100 formed of thermoelastic elastomer (e.g., the comparative example of Table 1 and/or Table 2) not including thermoplastic polyolefin to the washer 1.

Referring to Table 3, the washer 1 used in this experiment is a washer 1 capable of accommodating 25 kg of laundry. The noise level is the average of the noise levels generated every second, measured for a predetermined time. The vibration level is a record of the moving distance (displacement) of the main body 10 when 700g of specimen is put inside the drum 40 and the drum 40 is rotated at 1100 rpm.

Referring to Table 3, it may be identified that the noise level and the vibration level were reduced in embodiment 1 as compared with the comparative example. For example, it may be identified that, while the noise level is 53 dB and the vibration level is 0.51 mm in the washer 1 when applying the gasket 100 formed of the thermoelastic elastomer (comparative example) not including thermoplastic polyolefin, the noise level is 50.7 dB and the vibration level is 0.30 mm in the washer 1 when applying the gasket 100 formed of the thermoelastic elastomer (embodiment 1) including a predetermined level of thermoplastic polyolefin and thus the noise and vibration levels are reduced.

FIG. 4A illustrates morphology when TPO is prepared by a copolymerization method according to an embodiment of the disclosure.

FIG. 4B illustrates morphology when TPO is prepared by a simple blending type according to an embodiment of the disclosure.

The embodiments of FIGS. 4A and 4B may be selectively bonded with the embodiments of FIGS. 1 to 3.

According to an embodiment, the thermoplastic polyolefin may be prepared by a simple blending method, a crosslinking method partially crosslinking or completely crosslinking synthetic rubber such as ethylene-propylene diene monomer (EPDM) by dynamic vulcanization, and a copolymerization method of polypropylene and α-olefin (α-olefin), but preferably it may be prepared by the copolymerization method.

Referring to FIG. 4A, when the thermoplastic polyolefin is prepared in a copolymerization type, homo-PP may be used as the polypropylene. For example, the thermoplastic polyolefin may contain EPDM in the matrix of homo-PP as a domain-type dispersion phase.

According to an embodiment, the homo-PP constituting the matrix may be a polymer composed of only propylene monomers. The EPDM constituting the domain may be a polymer in which the ratio of the propylene monomer and the ethylene monomer is 4:6 to 6:4.

According to an embodiment, it may be identified that the homo-PP matrix indicated by a bright color is present as a dispersion phase of the EPDM domain indicated by a dark color. By adding a predetermined level of thermoplastic polyolefin, dispersibility of PP, EPDM, and SEBS, which are materials constituting the thermoplastic elastomer, may be enhanced, and thus hardness and flowability of the thermoplastic polyolefin may be enhanced due to the arrangement structure of homo-PP and EPDM.

Referring to FIG. 4B, when manufacturing thermoplastic polyolefin in a blending type, random-PP may be used as polypropylene. For example, the thermoplastic polyolefin, e.g., may have EPDM in the matrix of random-PP as a domain-type dispersion phase.

According to an embodiment, the random-PP constituting the matrix may be a polymer composed of the propylene monomer and the ethylene monomer. For example, the composition ratio of the propylene monomer constituting random-PP may be 95 to 97 wt %, and the composition ratio of the ethylene monomer constituting random-PP may be 3 to 5 wt %. The EPDM constituting the domain may be a polymer in which the ratio of the propylene monomer and the ethylene monomer is 4:6 to 6:4.

According to an embodiment, the dispersion of the EPDM domain indicated by a dark color is present in the homo-PP matrix indicated by a bright color, but the dispersion degree of the EPDM domain indicated by the dark color in the random-PP matrix indicated by the bright color in FIG. 4B is lower than in FIG. 4A. Accordingly, the thermoplastic polyolefin according to an embodiment of the disclosure may be preferably prepared by a copolymerization method of homo-PP and EPDM.

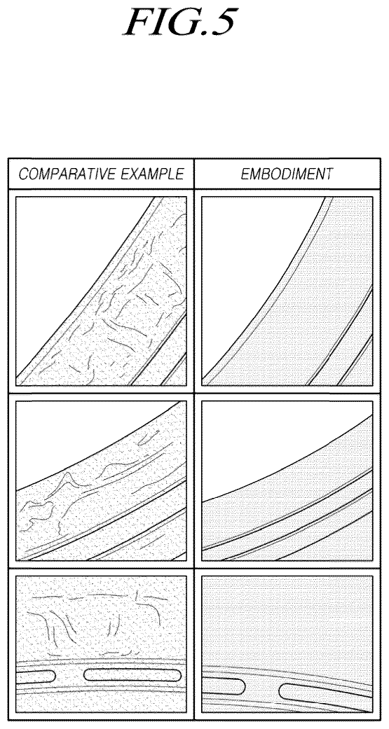

FIG. 5 illustrates a portion of a surface of a gasket (e.g., the gasket 100 of FIGS. 2 and 3) according to an embodiment of the disclosure

The embodiment of FIG. 5 may be selectively combined with the embodiments of FIGS. 1 to 4.

FIG. 5 illustrates comparison between a gasket 100 formed of thermoelastic elastomer (e.g., the comparative example of Tables 1, 2, and 3) not information indicating that thermoplastic polyolefin and a gasket 100 formed of elastomer (e.g., embodiment 1 or embodiment 2 of Tables 1 and 2 or embodiment 1 of Table 3) including a predetermined ratio of thermoplastic polyolefin.

According to an embodiment, it may be identified that the surface of the gasket 100 illustrated as the comparative example is rough, whereas the surface of the gasket 100 illustrated as the embodiment is smooth.

According to an embodiment, since the thermoplastic elastomer of the disclosure includes a predetermined ratio of thermoplastic polyolefin, flowability may be increased in a molten state while maintaining a predetermined degree of hardness. Since the thermoplastic elastomer has high flowability in a molten state, it is possible to prevent gas from penetrating into the injection-molding material when the thermoplastic elastomer in a molten state, which is the injection-molding material, is injected during the injection-molding process. Therefore, it is possible to reduce exterior defects when forming the gasket 100 formed of the thermoplastic elastomer.

According to an embodiment, due to the increased flowability of the thermoplastic elastomer of the disclosure, the gasket 100 may be injection-molded at a relatively low injection temperature of 180° C., and it is possible to reduce exterior defects due to gas when the gasket 100 is injection-molded at a relatively high injection-molding temperature of 200° C. or higher.

According to an embodiment, the thermoplastic elastomer of the disclosure maintains a predetermined level of flowability (0.7 to 2.1 g/10 min) while maintaining a predetermined degree of hardness (e.g., 31 to 33 Shore A), so that the gasket 100 formed of the thermoplastic elastomer may reduce vibration generated by the rotation of the drum 40 and noise caused by vibration. Therefore, the washer 1 of the disclosure may reduce the costs for additional devices for vibration and noise reduction by applying the thermoplastic elastomer as an injection-molding material for the gasket 100.

The washer 1 according to an embodiment of the disclosure relates to a gasket 100 disposed between the opening 10a formed in the main body 10 and the door 20 and a thermoplastic elastomer, which is a material for forming the gasket 100.

The washer 1 according to an embodiment of the disclosure includes a gasket 100 formed of a thermoplastic elastomer that maintains a predetermined level of hardness and flowability, thereby attenuating vibration generated when the drum 40 rotates and reducing noise generation.

The washer 1 according to an embodiment of the disclosure includes a gasket 100 formed of a thermoplastic elastomer that maintains a predetermined level of hardness and flowability, thereby reducing the cost of electronic components additionally required for vibration attenuation in addition to the gasket 100.

Effects obtainable from the disclosure are not limited to the above-mentioned effects, and other effects not mentioned may be apparent to one of ordinary skill in the art from the following description.

A washer (e.g., the washer 1 of FIG. 1) according to an embodiment of the disclosure may comprise a main body 10 including an opening 10a for putting in laundry, a door 20 configured to open or close the opening 10a, a tub 30 disposed in the main body 10, a drum 40 rotatably disposed in the tub 30, and a gasket 100 connecting the main body 10 and the tub 30, wherein when the door 20 is disposed to close the opening 10a, disposed to tightly contact the door 20. The gasket 100 may include a thermoplastic elastomer (TPE). The thermoplastic elastomer may include a styrene-ethylene-butylene-styrene (SEBS) block copolymer, a polypropylene (PP) copolymer, and 0.1 to 5 wt % of a thermoplastic polyolefin (TPO). The thermoplastic elastomer may have a hardness of 31 to 33 shore A

In the washer 1 according to an embodiment of the disclosure, the thermoplastic polyolefin may be present in an amount of 0.1 to 2 wt % based on a total weight of the thermoplastic elastomer.

In the washer 1 according to an embodiment of the disclosure, the thermoplastic polyolefin may be present in an amount of 1 to 2 wt % based on a total weight of the thermoplastic elastomer.

In the washer 1 according to an embodiment of the disclosure, the thermoplastic polyolefin is present in an amount of 0.025 to 0.05 wt % based on a weight of the SEBS.

In the washer 1 according to an embodiment of the disclosure, the thermoplastic polyolefin may be a composition formed by copolymerization of polypropylene and α-olefin.

In the washer 1 according to an embodiment of the disclosure, the polypropylene copolymer may include a random type polypropylene (PP) copolymer.

In the washer 1 according to an embodiment of the disclosure, the random type polypropylene copolymer may be composed of a compound of polypropylene and at least one of ethylene, butene, butadiene and synthetic rubber.

In the washer 1 according to an embodiment of the disclosure, a melt flow index (MFI) of the thermoplastic elastomer may be 0.5 to 2.5 g/10 min.

In the washer 1 according to an embodiment of the disclosure, the melt flow index (MFI) of the thermoplastic elastomer may be 1.5 to 2.1 g/10 min.

In the washer 1 according to an embodiment of the disclosure, the thermoplastic elastomer may further include modified polyphenylene ether (mPPE). The mPPE may be present in an amount of 1 to 5 wt % based on a total weight of the thermoplastic elastomer.

In the washer 1 according to an embodiment of the disclosure, a specific gravity of the thermoplastic elastomer may be 0.96 to 1.

A gasket 100 connecting a main body 10 and a tub 30 included in a washer 1, and configured to be in close contact with at least a portion of a door 20, according to an embodiment of the disclosure, may comprise a thermoplastic elastomer (TPE). The thermoplastic elastomer may include a styrene-ethylene-butylene-styrene (SEBS) block polymer, a polypropylene (PP) copolymer, and 0.1 to 5 wt % of a thermoplastic polyolefin TPO. The thermoplastic elastomer may have a hardness of 31 to 33 shore A

In the gasket 100 according to an embodiment of the disclosure, the thermoplastic polyolefin may be present in an amount of 0.1 to 2 wt % based on a total weight of the thermoplastic elastomer.

In the gasket 100 according to an embodiment of the disclosure, the thermoplastic polyolefin may be present in an amount of 1 to 2 wt % based on a total weight of the thermoplastic elastomer.

In the gasket 100 according to an embodiment of the disclosure, the thermoplastic polyolefin may be present in an amount of 0.025 to 0.05 wt % based on a weight of the SEBS.

In the gasket 100 according to an embodiment of the disclosure, the thermoplastic polyolefin may be a composition formed by copolymerization of polypropylene and α-olefin.

In the gasket 100 according to an embodiment of the disclosure, the polypropylene copolymer may include a random type polypropylene (PP) copolymer.

In the gasket 100 according to an embodiment of the disclosure, the random type polypropylene copolymer may be composed of a compound of polypropylene and at least one of ethylene, butene, butadiene and synthetic rubber.

In the gasket 100 according to an embodiment of the disclosure, a melt flow index (MFI) of the thermoplastic elastomer may be 0.5 to 2.5 g/10 min.

In the gasket 100 according to an embodiment of the disclosure, the melt flow index (MFI) of the thermoplastic elastomer may be 1.5 to 2.1 g/10 min.

In the gasket 100 according to an embodiment of the disclosure, the thermoplastic elastomer may further include modified polyphenylene ether (mPPE). The mPPE may be present in an amount of 1 to 5 wt % based on a total weight of the thermoplastic elastomer.

In the gasket 1 according to an embodiment of the disclosure, a specific gravity of the thermoplastic elastomer may be 0.96 to 1.

1. A washer comprising:
a main body including an opening configured to allow insertion of laundry into the main body;
a door configured to open or close the opening;
a tub in the main body;
a drum in the tub, the drum configured to be rotatable; and
a gasket connecting the main body and the tub so that, based on the opening being closed by the door, the gasket is in contact with at least a portion of the door,
wherein the gasket includes a thermoplastic elastomer (TPE) including:
a styrene-ethylene-butylene-styrene (SEBS) block copolymer,
a polypropylene (PP) copolymer, and
a thermoplastic polyolefin (TPO) of 0.1 to 5 wt % based on a total weight of the TPE, and
the TPE has a hardness of 31 to 33 shore A.

2. The washer of claim 1, wherein
the TPO is present in an amount of 0.1 to 2 wt % based on the total weight of the TPE.

3. The washer of claim 1, wherein
the TPO is present in an amount of 1 to 2 wt % based on the total weight of the TPE.

4. The washer of claim 1, wherein
the TPO is present in an amount of 0.025 to 0.05 wt % based on a weight of the SEBS block copolymer.

5. The washer of claim 1, wherein
the TPO is a composition formed by copolymerization of PP and α-olefin.

6. The washer of claim 1, wherein
the PP copolymer includes a random type PP copolymer.

7. The washer of claim 6, wherein
the random type PP copolymer is composed of a compound of PP and at least one of ethylene, butene, butadiene, and synthetic rubber.

8. The washer of claim 1, wherein
a melt flow index (MFI) of the TPE is 0.5 to 2.5 g/10 min.

9. The washer of claim 8, wherein
the melt flow index (MFI) of the TPE is 1.5 to 2.1 g/10 min.

10. The washer of claim 1, wherein
the TPE includes modified polyphenylene ether (mPPE), and
the mPPE is present in an amount of 1 to 5 wt % based on a total weight of the TPE.

11. The washer of claim 1, wherein
a specific gravity of the TPE is 0.96 to 1.

12. A gasket configured to connect a main body and a tub included in a washer, and configured to be in close contact with at least a portion of a door of the washer, the gasket comprising:
a thermoplastic elastomer (TPE) including:
a styrene-ethylene-butylene-styrene (SEBS) block polymer,
a polypropylene (PP) copolymer, and
a thermoplastic polyolefin (TPO) of 0.1 to 5 wt % based on a total weight of the TPE,
wherein the TPE has a hardness of 31 to 33 shore A.

13. The gasket of claim 12, wherein
the TPO is present in an amount of 0.1 to 2 wt % based on the total weight of the TPE.

14. The gasket of claim 12, wherein
the TPO is present in an amount of 1 to 2 wt % based on the total weight of the TPE.

15. The gasket of claim 12, wherein
the TPO is present in an amount of 0.025 to 0.05 wt % based on a weight of the SEBS block copolymer.

16. The gasket of claim 12, wherein
the thermoplastic polyolefin is a composition formed by copolymerization of PP and α-olefin.

17. The gasket of claim 12, wherein
the PP copolymer includes a random type PP copolymer.

18. The gasket of claim 17, wherein
the random type PP copolymer is composed of a compound of PP and at least one of ethylene, butene, butadiene and synthetic rubber.

19. The gasket of claim 12, wherein
a melt flow index (MFI) of the TPE is 0.5 to 2.5 g/10 min.

20. The gasket of claim 19, wherein
a melt flow index (MFI) of the TPE is 1.5 to 2.1 g/10 min.
